(19) United States
(12) Patent Application Publication
(10) Pub. No.: US 2010/0332419 A1
(43) Pub. Date: Dec. 30, 2010

(54) PRODUCT INTEGRATED FIBER BASED PACKAGE

(75) Inventor: Douglas Alan BIPPERT, Marietta, GA (US)

Correspondence Address: THE COCA-COLA COMPANY;PATENT & TECHNOLOGY DEPT--NAT 19, P. O. BOX 1734, ATLANTA, GA, 30301, US

(73) Assignee: THE COCA-COLA COMPANY, ATLANTA, GA (US)

(21) Appl. No.: 12/821,336

(22) Filed: Jun. 23, 2010

Related U.S. Application Data
(60) Provisional application No. 61/220,037, filed on Jun. 24, 2009.

(51) Int. Cl. B65D 85/72; G06Q 90/00

(52) U.S. Cl. 705/500; 426/106; 426/127; 426/87; 426/392

(57) ABSTRACT

A product-integrated fiber-based package includes fiber from the type of juice or vegetable contained therein. The packaging material includes at least one natural component derived from the same type of plant as the plant-based consumable product contained in the packaging material. The composition of the packaging is utilized in marketing the product.

### CROSS-REFERENCE TO RELATED APPLICATIONS

The present application claims priority to U.S. Provisional Application 61/220,037 filed Jun. 24, 2009, which is incorporated herein by reference in its entirety.

### TECHNICAL FIELD

The present disclosure relates broadly to systems and methods for packaging consumable food products. More particularly, the present disclosure relates to improved fiberboard packaging materials.

### BACKGROUND

The following discussion of the background is merely provided to aid the reader in understanding the invention and is not admitted to describe or constitute prior art.

Marketing products is an important function. Products are increasingly packaged in more sophisticated ways than in the past. The packaging or container used with a particular product usually displays information in an appealing and attractive manner, to encourage consumers to select that product from among other competing products.

Over the years, there have been numerous attempts to maximize consumer awareness of products in order to increase sales of the products. One way to increase consumer awareness is to advertise the product. This can, and has been done by many different means, including, but not limited to television, radio, print and other mass media, coupons, in-store advertising, direct mailing and emailing, catalogs and web site links and advertisements.

In other instances, the products may be placed in stores or shown on websites in ways to increase the likelihood that a consumer will see the product and purchase it. For example, retailers may place a particular product in a particular location of the store (e.g. the end of the aisle or along the check-out line) in an attempt to increase the product's visibility to the consumer.

Yet another way to entice consumers to purchase and try a particular product may be to provide the product with unique packaging. Such packaging may be unique in terms of its shape, functionality, appearance or any other aspect that may attract a potential buyer of the product. One proven method to gain and sustain product sales is to use unique identifiers on the product packaging.

Natural and organic products have become much more mainstream over the past few years and their popularity continues to rise. As the market continues to grow consumers will find it increasingly difficult to distinguish between brands, making it increasingly important for beverage companies to differentiate their brand via packaging initiatives. Packaging that lists features and benefits alone seeks out an intellectual response, it does not, however, elicit a prompt decision. Decision-making is a process. Packaging that appeals to the emotions of the consumer generally leads to action.

Furthermore, some products have certain qualities or benefits already associated with them. For example, beverages, such as juice are known to provide certain health benefits. In addition to considering these primary or known benefits associated with a product, a consumer may also consider secondary benefits that may not normally be associated with the product. In many instances, a consumer will consider enhanced primary or secondary benefits of the product when deciding which product to purchase. Some products which contain such enhanced primary or secondary benefits are packaged such that the text printed on the product packaging touts the improved features. It is often the case that the text that conveys the message is generic in form and does not separate itself from other packages in the retail space which may have similar messages.

Thus, there exists the need for a package and a method of marketing a product that provides the consumers with a product package that effectively, but simply, communicates specific primary and secondary benefits to the consumer. It is known that an average consumer has certain preconceived notions regarding the benefits of a product depending on the brand of product that is being sold. However, despite the numerous and continuing attempts to make consumers aware of products and to maintain and/or increase sales of such products, there still exists a need to provide packaging which is unique and increases the likelihood for consumer awareness.

Also, for health awareness conscience consumers, it is desirable to provide packaging that uses color and/or symbolism that evokes an emotional response from the consumer, shares a story and core brand attributes to position the product as unique and differentiated within its product categories and communicates a holistic message that the product inside is natural.

### SUMMARY

The present disclosure relates to a fiber-based package for a fruit or vegetable, whereby said fiber based package comprises fiber from the same type of plant as the juice or vegetable contained therein. In one aspect, the present disclosure provides a package of consumable products comprising a packaging material containing a plant-based consumable product, wherein the packaging material comprises at least one natural component derived from the same type of plant as the plant-based consumable product contained in the packaging material.

In one embodiment, the plant-based consumable product is a fruit or vegetable product. In one embodiment, the at least one natural component is a byproduct of the manufacturing of the plant-based consumable product. In one embodiment, the at least one natural component comprises plant skin, pulp, seeds or combinations thereof. In one embodiment, the at least one natural component is fiber from the same type of plant as the plant-based consumable product contained in the packaging material. In one embodiment, the packaging material comprises a core of paper, paperboard, cardboard or fiber board. In one embodiment, the packaging material is biodegradable.

In one embodiment, the packaging material comprises a heat-sealable barrier laminate of paperboard sandwiched between two layers of polyethylene. In one embodiment, the paperboard comprises at least 1% by weight of the at least one natural component of a plant derived from the same type of plant as the plant-based consumable product contained in the packaging material. In one embodiment, the paperboard comprises at least 5% by weight of the at least one natural component of a plant derived from the same type of plant as the plant-based consumable product contained in the packaging material.

In one embodiment, the at least one natural component is orange peel and the plant-based consumable product comprises orange juice. In one embodiment, the at least one natural component is apple seeds, apple skins, apple stems, apple pulp or a combination thereof, and the plant-based consumable product comprises apple juice or apple sauce. In one embodiment, the at least one natural component is lemon peel and the plant-based consumable product comprises lemonade or lemon juice. In one embodiment, the at least one natural component is skin from a tomato fruit and the plant-based consumable product comprises tomato juice. In one embodiment, the at least one natural component is grape seeds, grape skins, grape stems, grape pulp or a combination thereof, and the plant-based consumable product comprises grape juice or wine. In one embodiment, the at least one natural component is prune skins, prune pits, prune stems, or a combination thereof, and the plant-based consumable product comprises prune juice. In one embodiment, the at least one natural component is pineapple skins, pineapple pulp or a combination thereof, and the plant-based consumable product comprises pineapple juice. In one embodiment, the at least one natural component is guava skins, guava seeds or guava pulp or a combination thereof, and the plant-based consumable product comprises guava juice.

In one embodiment, the packaging material includes indicia identifying that the packaging material comprises at least one natural component of a plant derived from the same type of plant as the plant-based consumable product contained in the packaging material.

The present disclosure further provides a method of marketing a food product, for example, juice, to a food product customer. In one embodiment, the method comprises: (i) producing a fruit or vegetable-containing food product; (ii) packaging the food product for retail sale in a packaging material, wherein the packaging material comprises at least one natural component of a plant derived from the same type of plant as the fruit or vegetable-containing food product, and (iii) communicating to a consumer that said fruit or vegetable containing food product is packaged in container that is made of a fruit or vegetable. In one embodiment, after a fruit or vegetable containing food product is produced; the food product for retail sale is packaged, wherein the packaging comprises an extract from a fruit or vegetable that is of the same type of said fruit or vegetable contained in said food product. Marketing communicates to a consumer that said fruit or vegetable containing food product is packaged in container which made of a fruit or vegetable. In one embodiment, the food product is a beverage. In yet another embodiment, the food product is fruit juice. In still yet another embodiment, the food product is a vegetable juice.

Additional features and advantages are realized through the techniques of the present disclosure. Other embodiments and aspects of the invention are described in detail herein and are considered a part of the claimed invention.

### DETAILED DESCRIPTION

The definitions of certain terms as used in this specification are provided below. Unless defined otherwise, all technical terms used herein generally have the same meaning as commonly understood by one of ordinary skill in the art to which this invention belongs.

“Brand logo”, as used herein, refers to indicia associated with a particular product or product line. The brand logo may include any combination of words, symbols, pictures or other graphic or textual elements.

“Brand name”, as used herein, refers to a name for a product or product line. Generally, such brand names are trade names or trademarks, but can also include generic or descriptive language.

“Consumer”, as used herein, refers to any person that purchases, makes a decision to purchase a product or is contemplating making a purchase of a product. Typically, the Consumer will be the end user of the product, but the definition of consumer, as used herein is not so limited.

“Display area” as used herein refers to portion of the outer package which is intended to be displayed to a consumer when the package is displayed for sale.

“Equity building advertising”, as used herein, refers to a message about one or more of the benefits of a product. The equity building advertising can include letters, text, words, graphics, symbols, pictures or any other indicia related to the benefits of a product.

“Fruit,” as used herein, refers to any product of plant growth useful to humans or animals.

“Product Information”, as used herein, refers to information about one or more qualities of a product. The product information can include letters, text, words, graphics, symbols, pictures or any other indicia related to the benefits of a product.

“Package”, as used herein, refers to any covering material or wrapper in which at least a portion of a product is placed for shipping, storage and/or sale. Examples of “packages” include boxes, cups, jars, bottles, plates, cartons, cases, crates, dishes, lids, other types of holders, and cushioning materials therein. It will be appreciated that in certain circumstances the container may seal the contents from the external atmosphere and in other circumstances may merely hold or retain the items.

The term “disposable” refers to packages or containers which have the characteristics typically associated with disposable containers on the market. That is to say, the food or beverage container (a) is manufactured in such a way that it is economical for the container to be used only once and then discarded, and (b) has a construction such that it can be readily discarded or thrown away in conventional waste landfill areas as an environmentally neutral material (without causing significant extraordinary environmental hazards). The use of the term “disposable” does not mean that the container must necessarily only be a single-use food or beverage container and be discarded after only one use.

“Primary product” refers to the major product being sold. In one embodiment, a primary product is a juice beverage. Exemplary juice beverages include, but are not limited to: fruit, vegetable, and combinations thereof.

“Product”, as used herein, refers to any object, material or substance that is intended for use by a consumer.

“Vegetables”, as used herein, refers to any plant whose fruit, seeds, roots, tubers, bulbs, stems, leaves, or flower parts are used as food, as the tomato, bean, beet, potato, onion, asparagus, spinach, or cauliflower.

As used herein, the terms “beverage,” “beverage component,” and “beverage composition” each refer to a liquid that is appropriate for human or animal consumption.

As noted above, the present disclosure includes an improved package for products. As with most packages, the package of the present disclosure provides a means for storing, shipping, protecting, containing and/or displaying the product or products that are disposed within or partially within the package. Packages are also used to identify the product(s) therein and provide the consumer with general information about the product. The package of the present disclosure provides an improvement in that it includes at least one natural component derived from the same plant as a plant-based consumable product contained within the package.

Advantageously, various embodiments provide techniques for marketing and purveying a food product based upon natural holistic characteristics. The natural characteristics may be, for example, the concept of a “natural package” that is related to the product contained therein. Still further, the natural characteristics may be shown on a product display associated with the food product. For example, with various embodiments, a food product such as juice may be shown packaged by natural products. For example, apple juice contained in a cored apple peel may be shown on the display area of a package or display case.

As described herein, representative embodiments include an improved package for food products. In one embodiment, there is provided a package for beverages. However, the package is in no way limited to a particular type or category of food products. Thus, the package can be useful with any food product therein. Further, the package may include a single product or several products (e.g., multi-serve beverages).

The package provides a means for storing, shipping, protecting, containing and/or displaying the product or products that are disposed within or partially within the package. The package is also used to identify the product(s) therein and provide the consumer with general information about the product.

In one embodiment the product is a beverage. The beverage can be a ready-to-drink beverage, e.g. single strength or alternatively a drink base, e.g., as a concentrated drink base, for combination with additional beverage components, and/or water, and/or nutrient additives, and/or optional ingredients. In one embodiment, the beverage is a fruit juice, vegetable juice, or a combination thereof. Optionally the beverage may comprise a beverage component and/or water. In one embodiment, the Primary Product is juice derived from a plant product. In a suitable embodiment, the juice is a fruit or vegetable juice.

The fruit juice may be chosen from, but is not limited to, orange juice, apple juice, grape juice, pear juice, cranberry juice, raspberry juice, strawberry juice, blueberry juice, blackberry juice, gooseberry juice, elderberry juice, cherry juice, currant juice, pineapple juice, lemon juice, lime juice, grapefruit juice, quince juice, plum juice, prickly pear juice, tangelo juice, pomelo juice, calamondin juice, mango juice, banana juice, kiwi juice, peach juice, nectarine juice, apricot juice, tangerine juice, clementine juice, minneolas juice, satsuma juice, mandarin orange juice, kumquat juice, pomegranate juice, watermelon juice, honeydew melon juice, cantaloupe melon juice, guava juice, papaya juice, passion fruit juice, star fruit juice, tamarind juice, cupuaca juice, and/or mixtures thereof. Further for example, the fruit juice is chosen from orange juice, apple juice, grape juice, and mixtures thereof.

The vegetable juice may include but is not limited to, juice from tomatoes, carrots, spinach, peppers, cabbage, sprouts, broccoli, potatoes, celery, anise (fennel), cucumbers, parsley, cilantro, beets, wheat grass, asparagus, zucchini, squash, rhubarb, turnips, rutabagas, parsnips, radishes, watercress, endive, escarole, lettuce, spinach, garlic, onion, ginger, and/or mixtures thereof.

The beverage component may comprise any beverage component that can be mixed with at least one fruit or vegetable juice. For example, the beverage component can be chosen from, but is not limited to, dairy milk, soy milk, rice milk, coconut milk, botanical extracts, teas, coffees, protein drinks, protein emulsions, meal replacement drinks, sports drinks, energy drinks, soft drinks, carbonated drinks, frozen carbonated beverages, frozen uncarbonated beverages, functional drinks (i.e. nutraceuticals or drinks containing functional additives or components), health drinks, nectars, smoothies, shakes, tonics, horchata (i.e., vegetable and/or rice components made into a beverage), syrups, cordials, dilutable drinks, and mixtures thereof. The beverage component may comprise a single strength beverage component (for example, fresh milk) or it may comprise a concentrated beverage component (for example, concentrated milk prepared from a milk powder, or evaporated milk).

In one embodiment, the packaging material has a core layer of fiber-based material or other material, such as plastic. Examples of usable fiber-based materials for the core layer may be paper or paperboard of conventional packaging quality, while examples of usable plastics may be polyolefin, e.g. polyethylene, polypropylene and copolymers of ethylene and propylene, polyester, polyamide, etc. Without departing from the inventive concept as herein disclosed, the plastic may also include natural products admixed into the plastic, if desired.

In on embodiment, on both sides of the core layer, there are disposed outer liquid-tight coatings of plastic which may consist of an extrudable thermoplastic, suitably polyethylene. The choice of an extrudable thermoplastic, such as polyethylene, for both of the outer plastic coatings, renders the laminated packaging material sealable in such a manner that mutually facing plastic coatings may readily be sealed to one another by surface fusion by means of conventional heat sealing techniques, as a person skilled in this art will already be aware.

In an illustrative embodiment, the package is a laminated package suitable for use as heat-sealable packages for liquid food or beverages, such as milk, cream and juice cartons. The material used to form the package generally comprises a core of fiber, for example, paper, paperboard, cardboard or fiber board. The existing commercial structure for a paperboard carton package for juice and similar products utilizes an easily heat-sealable barrier laminate composed of paperboard sandwiched between two layers of polyethylene.

The package is made using at least one natural component of a plant product of the type contained in the Primary Product. In some embodiments, the primary product is at least 10%, at least 20%, at least 30%, at least 40%, at least 50%, at least 60%, at least 75%, at least 90%, at least 95%, or at least 99% by weight of the material contained in the package. For example, if the primary product is 100% apple juice, then the package is made of at least one natural component of apples. In another example, if the primer product contains at least 50% grape juice, then the package is made of at least one component of apples. In one embodiment, the product does not contain more than 1%, more than 5%, more than 10%, more than 20%, or more than 50% corn or corn starch.

In one embodiment, the package is made using at least one natural component from at least one fruit or vegetable that is of the type of the Primary Product. Alternatively, the package may be made using one or more natural components of the type used of the Primary Product. Any suitable natural component of a plant product may be used. In one embodiment, the natural component is a byproduct of the plant product, for example, the natural component may comprise plant skin, pulp, seeds or combinations thereof. In one embodiment, the natural component is easily mixed with a component or additive of the package. For example, the natural component may include a fiber that can be easily mixed with the fiber core of the package or other additives used to make the package. In some embodiments, the natural component is mixed with the fiber core of the package in an amount that is at least 1%, 2%, 5%, 10%, 15%, 20%, 25%, 30%, 50%, or 75% or more by weight of the fiber core. In some embodiments, the natural component is mixed with the fiber core of the package in an amount that is from about 1%-5%, 1%-10%, 1%-25%, or 1-50% by weight of the fiber core. The amount of the natural component that is mixed with the fiber core of the package is selected so as use the maximum amount of the natural component possible without sacrificing the structural integrity of the packaging material.

In one embodiment, there is provided an orange juice package. The orange juice package may be a fiber-based package that comprises orange peel. In yet another embodiment, there is provide an apple juice package that comprises apple seeds, apple skins, apple stems, apple pulp or a combination thereof. In yet another embodiment, there is provided a tomato juice package comprising skin from a tomato plant, tomato plant stems, or combinations thereof. In still yet another embodiment there is provided a lemon juice package made using lemon peel.

Representative embodiments include a method of marketing that provides consumers with a product package which effectively presents communicative indicia to inform consumers of a benefit associated with that product. As previously discussed, beverages, such as juice, are known to provide certain health benefits. In addition to considering these primary or known benefits associated with a product, a consumer may also consider secondary benefits that may not normally associated with the product when deciding which product to purchase. The package conveys a message in a unique form and separates itself from other packages in the retail space which may have similar messages.

Benefits include, but are not limited to, natural, holistic, healthy, well-being, organic, family friendly, and combinations thereof. For example, pomegranate juice has received a great deal of attention in recent years for its reported benefits as being a rich source of antioxidants and ability to lower LDL cholesterol, slow the growth of prostate cancer, stabilize the levels of men's prostate specific antigen, and increase blood flow to the heart in people with ischemic coronary heart disease; orange juice may help people prevent recurrences of painful kidney stones; cranberry juice appears to be effective at preventing urinary tract infections (UTIs); and blueberry juice has some of the same properties as cranberries that allow it to prevent UTIs. All of which promote the primary benefits associated with juice. A package provides a secondary product which communicates a desirable quality, or benefit, that further enhances the primary product benefits, i.e., a juice packaged in its own skin or food product packaged in its natural byproduct.

In one embodiment, the food product package is made from said food product. The food product package is a secondary product and further comprises one or more indicators that inform consumers of benefits associated with the food product. In an embodiment of the invention, the secondary product is indicia further communicating benefits of the associated food product. Specifically, the secondary product is natural packaging further indicating the natural benefits of the food product contained therein.

In one embodiment, a food product, such as a juice beverage, is produced. The beverage has a primary benefit of being natural, holistic, healthy, organic, family friendly, or combinations thereof. The juice beverage is then packaged for retail sale in a package that is made from a natural component of the plant product used to produce the juice packaged therein. The juice beverage package is provided with a primary or brand logo that is associated by consumers with the juice beverage. For example, if the juice beverage package contains a primary brand, for example MINUTE MAID, then the package will have indicia that is associated by text, graphics, or some combination thereof to MINUTE MAID. The brand logo may be included anywhere on the display area. The natural juice beverage package provides a secondary product that enhances the primary benefit. The secondary product, i.e., the package would also include secondary indicia that the package is made from a natural byproduct or component of the juice contained therein. The juice beverage product package is transported to a retail location and is exposed to the consumer. The brand logo and the secondary indicia is exposed to the consumer.

Equity building advertising and/or product information may be included anywhere on the display area. In addition, the package may include a brand name and/or brand logo. The brand name/brand logo is disposed on the display area and is intended to help the consumer identify the particular product within the package and possibly the manufacturer or distributor of the product. However, in some cases, the package may not include any brand name/brand logo on the display area. In certain embodiments, the package may also include decorative indicia and/or technical or other written information about the make-up of the product package.

While representative embodiments have been described, it will be understood that those skilled in the art, both now and in the future, may make various improvements and enhancements which fall within the scope of the claims which follow.

What is claimed is:

1. A package for consumable products comprising a packaging material containing a plant-based consumable product, wherein the packaging material comprises at least one natural component derived from the same type of plant as the plant-based consumable product contained in the packaging material.

2. The package of claim 1, wherein the plant based consumable product is a fruit or vegetable product.

3. The package of claim 1, wherein the at least one natural component is a byproduct of the manufacturing of the plant-based consumable product.

4. The package of claim 3, wherein the at least one natural component comprises plant skin, pulp, seeds or combinations thereof.

5. The package of claim 3, wherein the at least one natural component is fiber from the same type of plant as the plant-based consumable product contained in the packaging material.

6. The package of claim 1, wherein the packaging material comprises a core of paper, paperboard, cardboard or fiber board.

7. The package of claim 1, wherein the packaging material comprises a heat-sealable barrier laminate of paperboard sandwiched between two layers of polyethylene.

8. The package of claim 7, wherein the paperboard comprises at least 1% by weight of the at least one natural component of a plant derived from the same type of plant as the plant-based consumable product contained in the packaging material.

9. The package of claim 7, wherein the paperboard comprises at least 5% by weight of the at least one natural component of a plant derived from the same type of plant as the plant-based consumable product contained in the packaging material.

10. The package of claim 1, wherein the packaging material is biodegradable.

11. The package of claim 1, wherein the at least one natural component is orange peel and the plant-based consumable product comprises orange juice.

12. The package of claim 1, wherein the at least one natural component is apple seeds, apple skins, apple stems, apple pulp or a combination thereof, and the plant-based consumable product comprises apple juice or apple sauce.

13. The package of claim 1, wherein the at least one natural component is lemon peel and the plant-based consumable product comprises lemonade or lemon juice.

14. The package of claim 1, wherein the at least one natural component is skin from a tomato fruit and the plant-based consumable product comprises tomato juice.

15. The package of claim 1, wherein the at least one natural component is grape seeds, grape skins, grape stems, grape pulp or a combination thereof, and the plant-based consumable product comprises grape juice or wine.

16. The package of claim 1, wherein the at least one natural component is prune skins, prune pits, prune stems, or a combination thereof, and the plant-based consumable product comprises prune juice.

17. The package of claim 1, wherein the at least one natural component is pineapple skins, pineapple pulp or a combination thereof, and the plant-based consumable product comprises pineapple juice.

18. The package of claim 1, wherein the packaging material includes indicia identifying that the package comprises at least one natural component of a plant derived from the same type of plant as the plant-based consumable product contained in the packaging material.

19. A method of marketing a food product to a consumer, the method comprising:
(i) packaging a plant-based food product in a packaging material, wherein the packaging material comprises at least one natural component of a plant derived from the same type of plant as the food product.

20. The method of claim 19 further comprising:
(ii) communicating to a consumer that the plant-based food product is packaged in container that is derived from the same type of plant as the food product.
